(19) United States
(12) Patent Application Publication
(10) Pub. No.: US 2020/0134308 A1
(43) Pub. Date: Apr. 30, 2020

(54) CONFIGURING AND PERFORMING CHARACTER PATTERN RECOGNITION IN A DATA PLANE CIRCUIT

(71) Applicant: Barefoot Networks, Inc., Santa Clara, CA (US)

(72) Inventors: Masoud Moshref Javadi, Sunnyvale, CA (US); Robert Soule, San Carlos, CA (US); Changhoon Kim, Palo Alto, CA (US); Jeongkeun Lee, Mountain View, CA (US); John Nathan Foster, Ithaca, NY (US); Daniel A. Alvarez, Oakland, CA (US); Theodore Jepsen, Pregassona (CH)

(21) Appl. No.: 16/590,338

(22) Filed: Oct. 1, 2019

Related U.S. Application Data
(60) Provisional application No. 62/751,832, filed on Oct. 29, 2018.

(51) Int. Cl. G06K 9/00; H04L 12/58; G06F 40/30; G06F 40/284

(52) U.S. Cl. CPC G06K 9/00442; H04L 51/00; G06K 2209/01; G06F 40/284; G06F 40/30

(57) ABSTRACT

Some embodiments of the invention provide a data plane circuit for a network forwarding element that searches for one or more patterns of characters stored in data messages received by the data plane circuit. In some embodiments, the data plane circuit analyzes the data messages as it processes the data messages to forward the data messages to their destinations in a network. Because the data messages are already flowing through the network, it is optimal to search the data messages for the character patterns as the data messages pass through the network, instead of performing these operations on a separate set of servers that typically perform these searches at slower rates. In other embodiments, the data plane circuit does not perform its character pattern searches in conjunction with its forwarding operations, as it receives the data messages from a set of servers just for the purpose of performing its character pattern searches, in order to offload some or all of these searches from the server set.

### BACKGROUND

It is estimated that 80% of enterprise data is unstructured or semi-unstructured. Examples of such data include e-mail, tweets, log files, etc. This data is not straight-forward for machines to consume, as it contains text written by users. In recent years, analytics systems have been proposed that process large datasets of unstructured data to extract some information from these datasets. In most cases, only a small subset of the data actually contains useful information. As a result, these systems waste a lot of time and resources filtering out irrelevant data.

Recent systems have used more efficient text searches by using general purpose processors, GPUs and FPGAs. In parallel, these systems have also explored the complexity of the search patterns—in terms of quantity, size, similarity, and regex complexity. These systems support complex patterns and some even have relatively high throughput, on the order of gigabits per second. However, these systems cannot cope with the growing bandwidth in data centers.

### BRIEF SUMMARY

Some embodiments of the invention provide a data plane circuit for a network forwarding element that searches for one or more patterns of characters stored in data messages received by the data plane circuit. In some embodiments, the data plane circuit analyzes the data messages as it processes the data messages to forward the data messages to their destinations in a network. Because the data messages are already flowing through the network, it is optimal to search the data messages for the character patterns as the data messages pass through the network, instead of performing these operations on a separate set of servers that typically perform these searches at slower rates. In other embodiments, the data plane circuit does not perform its character pattern searches in conjunction with its forwarding operations, as it receives the data messages from a set of servers just for the purpose of performing its character pattern searches, in order to offload some or all of these searches from the server set.

In some embodiments, the data plane circuit is a custom programmable switching ASIC (application specific integrated circuit) that includes multiple pipelines of message processing stages. These pipelines are organized into a set of ingress pipelines and a set of egress pipelines, with a traffic-managing crossbar switch in between these two sets to direct data message flows from ingress pipelines to egress pipelines (e.g., based on ingress-side message processing). In some embodiments, the data plane circuit is configured to recirculate a data message when the data plane circuit cannot check all the characters stored in the data message after having the data message traverse through one or more passes of a message processing pipeline (e.g., in one or more passes through an ingress pipeline followed by an egress pipeline) of the data plane circuit.

Some embodiments provide a compiler that compiles search character patterns into one or more state machines that are used to configure the message processing stages of the data plane circuit. These message processing stages run at the message-process line rate of the data plane circuit to search for character patterns in the message payload data that match the patterns that are the subject of the search. In some embodiments, each state machine includes (1) several states comprising partial-pattern states and at least one full-pattern state and (2) several transitions between the states, with each transition associated with a match of a set of characters in a data message and at least a portion of at least one pattern. The state machine transitions in some embodiments include at least one transition that is associated with a match of several characters in a data message with a multi-character portion of at least one pattern.

To configure the message processing stages, the compiler in some embodiments provides to the data plane circuit configuration data that specifies records for match-action tables of the message processing stages. The compiler in some embodiments provides configuration data to the data plane circuit through out-of-band communication with a control plane circuit associated with the data plane circuit, and this control plane circuit then configures the data plane circuit based on the received configuration data. This control plane in some embodiments is a local control plane on the same device (e.g., same forwarding element) as the data plane circuit, while in other embodiments it is a remote control plane operating on a device separate from the data plane circuit. In other embodiments, the compiler provides configuration data to the data plane circuit through in-band communication, i.e., through data messages that the data plane circuit receives through its physical ports and MAC (media access control) interface. In some of these embodiments, the data plane circuit forwards the data payload of the in-band received messages to its local control plane, which, in turn, configures the data plane circuit.

The match-action records in the received configuration data in some embodiments configure one or more message-processing stages of the data plane circuit to implement the state machine. With this implemented state machine, the data plane circuit can then search data messages to identify one or more character patterns in the data messages. For instance, in some embodiments, the message processing stages include match-action units, and the configuration data specifies several match-action record pairs for the match-action units to store. Each match-action pair in some embodiments includes (1) a match parameter set that includes a first state of the state machine and a set of characters, and (2) an action parameter set that specifies a second state. When a current state of the state machine and an examined portion of a character string stored in a data message match the match parameter set of a particular match-action pair, the match-action unit that implements the particular match-action pair changes the current state of the state machine from the first state to the second state.

In some embodiments, the set of characters of each match parameter set in a group of match parameter sets for a group of match-action pairs can include more than one character. For at least a subset of match parameter sets, some embodiments allow each particular character set in at least a subset of the character sets with more than one character to have at least one wildcard character that matches any potential character in a character portion that is being compared to the character set.

The match-action units in some embodiments can include a TCAM (ternary content addressable memory) and/or an SRAM (static random access memory). Some embodiments use the TCAM of a match-action unit to store match parameter sets with at least one wildcard character, while using the SRAM match tables to store match parameter sets that do not use wildcard characters. When one set of characters in a data message matches match parameter sets in the TCAM and SRAM match tables, the SRAM match parameter set in some embodiments is identified as the matching match parameter set. Also, when one set of characters in a data message matches several match parameter sets in the TCAM match table, the match parameter set with the highest priority in the TCAM match table is identified as the matching match parameter set.

Some embodiments store a set of characters of a match parameter set in an SRAM memory in terms of the hash of the set of characters instead of storing the set of characters in order to reduce the size of the SRAM match records. In these embodiments, the data plane circuit is configured to compare several characters in a data message with a set of characters of a match parameter set by first generating a hash value of the data message characters and comparing the hash value with the hash of the set of characters that are stored in the match parameter set.

The pattern-identifying operations of some embodiments can be grouped into three parts: (1) compiling patterns into a state machine, which in some embodiments is a deterministic finite state automaton (DFA), (2) translating the state machine into switch tables that leverage different types of memory, and (3) executing that DFA in the switch pipeline to match packets. Each message-processing stage of the data plane circuit in some embodiments has several MAU subsets. In some of these embodiments, the compiler divides the generated state machine into a set of several smaller state machines, and then configures the several MAU subsets of each of several stages (or all the stages) to implement the set of smaller state machines in parallel.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF FIGURES

The novel features of the invention are set forth in the appended claims. However, for purposes of explanation, several embodiments of the invention are set forth in the following figures.

FIG. 1 illustrates a system for using a data plane circuit to search of patterns.

FIG. 2 illustrates a process performed by the server in some embodiments.

FIG. 3 illustrates a single stride state machine.

FIG. 4 illustrates a multi-stride state machine.

FIG. 5 illustrates examples of TCAM and SRAM match tables.

FIG. 6 illustrates two examples of exact-match records in two different SRAM match tables.

FIG. 7 illustrates an example of splitting one large state machine into multiple smaller state machines in order to reduce the amount of resources consumed to perform the stateful tracking of patterns.

FIG. 8 illustrates a process that each pattern-identifying MAU stage of the data plane circuit performs in some embodiments.

FIG. 9 illustrates an example of a forwarding element with a data plane circuit that can be configured to implement one or more state machines that can search character strings stored in the data messages that the data plane circuit processes.

FIG. 10 illustrates a match action unit of some embodiments.

FIG. 11 illustrates an alternative system for using the data plane circuit to search of patterns.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a data plane circuit for a network forwarding element that searches for one or more patterns of characters stored in data messages received by the data plane circuit. In some embodiments, the data plane circuit is a custom programmable switching ASIC (application specific integrated circuit) that includes multiple pipelines of message processing stages. Some embodiments provide a compiler that compiles search character patterns into one or more state machines that are used to configure the message processing stages of the data plane circuit. These message processing stages run at the message-process line rate of the data plane circuit to search for character patterns in the message payload data that match the patterns that are the subject of the search. In some embodiments, each state machine includes (1) several states comprising partial-pattern states and at least one full-pattern state and (2) several transitions between the states, with each transition associated with a match of a set of characters in a data message and at least a portion of at least one pattern. The state machine transitions in some embodiments include at least one transition that is associated with a match of several characters in a data message with a multi-character portion of at least one pattern.

To configure the message processing stages, the compiler in some embodiments provides to the data plane circuit configuration data that specifies records for match-action tables of the message processing stages. These records in some embodiments configure one or more message-processing stages of the data plane circuit to implement the state machine. With this implemented state machine, the data plane circuit can then search data messages to identify one or more character patterns in the data messages.

For instance, in some embodiments, the message processing stages includes match-action units, and the configuration data specifies several match-action record pairs for the match-action units to store. Each match-action pair in some embodiments includes (1) a match parameter set that includes a first state of the state machine and a set of characters, and (2) an action parameter set that specifies a second state. When a current state of the state machine and an examined portion of a character string stored in a data message matches the match parameter set of a particular match-action pair, the match-action unit that implements the particular match-action pair changes the current state of the state machine from the first state to the second state.

In this document, data messages refer to a collection of bits in a particular format sent across a network. One of ordinary skill in the art will recognize that the term data message may be used herein to refer to various formatted collections of bits that may be sent across a network, such as Ethernet frames, IP packets, TCP segments, UDP datagrams, etc. Also, as used in this document, references to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model.

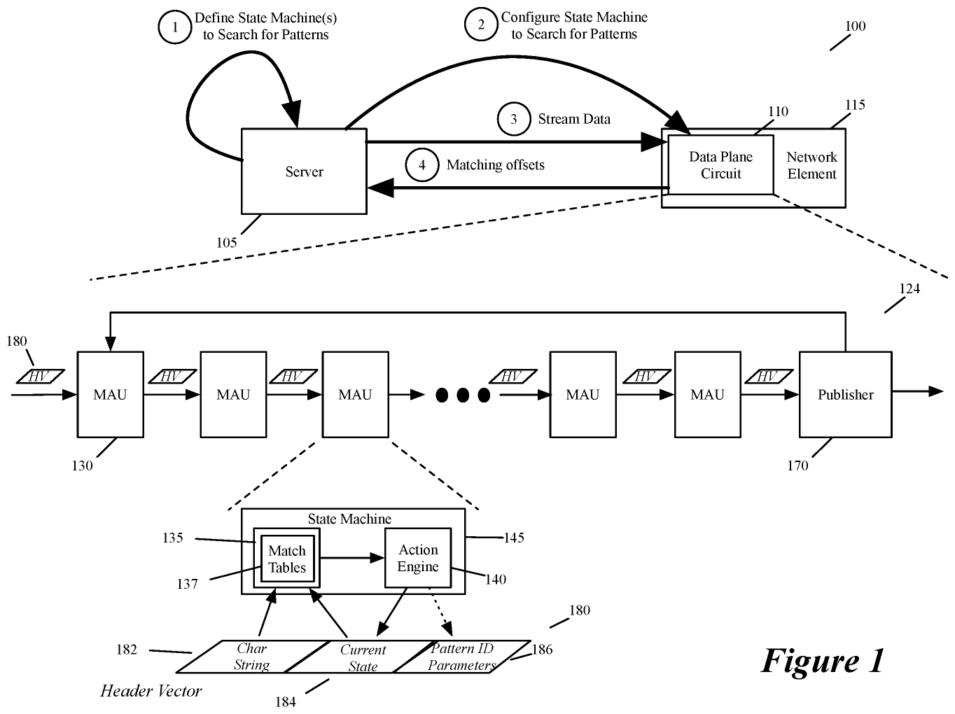

FIG. 1 presents a diagram that illustrates the interaction between a server 105 and a data plane circuit 110 in a pattern-identifying system 100 of some embodiments. The pattern-identifying operations of the system 100 can be grouped into three parts: (1) the server 105 compiling patterns into one or more state machines, which in some embodiments is a deterministic finite state automaton (DFA), (2) the server 105 translating the DFA into message-processing table records for the data plane circuit 110 and providing these records to the data plane circuit to program the data plane circuit to implement the state machine(s), and (3) the data plane circuit 110 using these records while processing the data messages to try to identify patterns in the characters stored in the data messages. Before translating the DFA into message-processing table records, the server 105 in some embodiments uses known graph partitioning techniques to simplify the DFA (e.g., by reducing the number of edges in the DFA).

The server 105 executes on a server that is separate from a network element 115 that includes the data plane circuit 110. In FIG. 1, the network element 115 is an appliance that has its data plane circuit 110 configured by the server 105 to search for character patterns in streams of data messages sent by the compiler. Specifically, in this example, the server 105 first defines one or more state machines for searching for one or more character patterns, then supplies configuration data to configure the data plane circuit 110 (e.g., the data plane table records) to implement the defined state machine(s), and then forwards data messages to the network element 115 for the data plane circuit to analyze to determine whether the data messages contain any of the character patterns specified by the state machines.

In some embodiments, the server 105 embeds the character strings that the data plane has to search in the data messages that it forwards to the data plane circuit 110, as further described below. The server forwards the data messages to the data plane circuit 110 of the network element 115 in order to offload the computationally intensive task of searching for character patterns in one or more character strings. The data plane circuit 110 can perform these operations very quickly at its data message processing line rate, as the data plane circuit in some embodiments is a custom programmable switching ASIC (application specific integrated circuit) that includes multiple pipelines of message processing stages that operate at very fast message processing rates.

In some embodiments, each state machine that is implemented on the configured data plane circuit 110 searches the character strings in the data messages, in order to try to identify one or more character patterns in the received character strings. Whenever a state machine determines that a configured character pattern is contained in a data message, it provides a set of pattern-identifying parameters for the identified character pattern. In some embodiments, the pattern-identifying parameter set for an identified character pattern includes a pattern identifier that specifies the identified matched pattern, and a location identifier that specifies the location of the matched pattern in the character string of the data message that contained the matched pattern. The pattern-identifying parameter set is specified differently in other embodiments.

Instead of just being an appliance for searching character strings, the network element 115 in other embodiments is a forwarding element that performs its pattern-identifying operations in conjunction with the message forwarding operations that it performs to forward data messages in the network. In these embodiments, the data plane circuit analyzes the data messages as it processes the data messages to forward the data messages to their destinations in the network. Because the data messages are already flowing through the network, it is optimal to search the data messages for the character patterns as the data messages pass through the network, instead of performing these operations on a separate set of servers that typically perform these searches at slower rates.

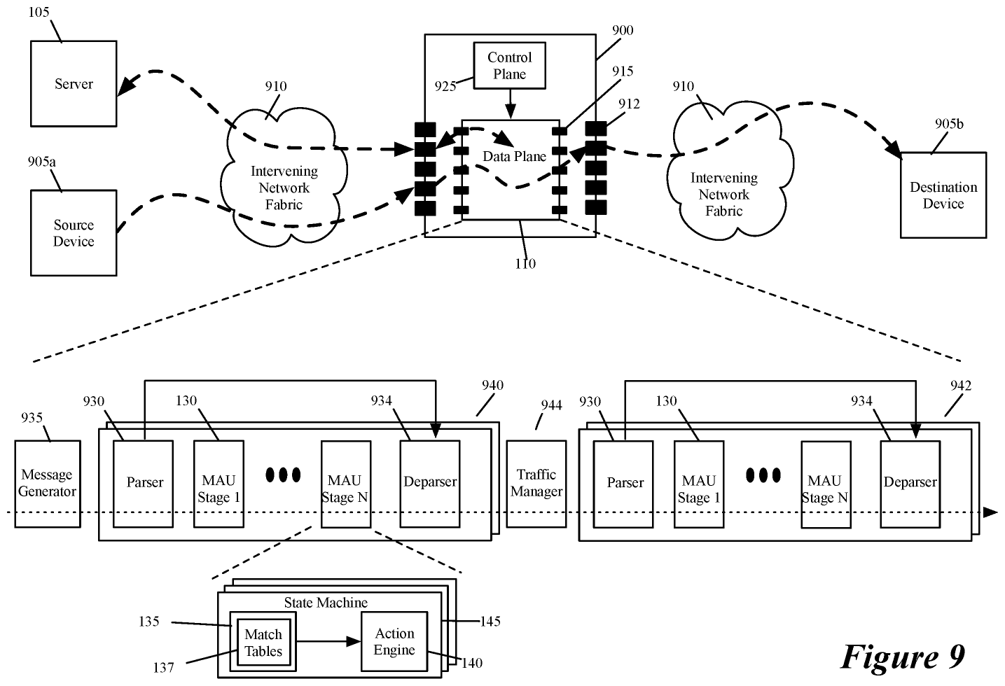

As mentioned above, the data plane circuit in some embodiments is a custom programmable switching ASIC (application specific integrated circuit) that includes multiple pipelines of message processing stages that operate at very fast message processing rates. In some embodiments, these pipelines are organized into a set of ingress pipelines and a set of egress pipelines, with a traffic-managing crossbar switch in between these two sets to direct data message flows from ingress pipelines to egress pipelines (e.g., based on ingress-side message processing). These ingress/egress pipelines and traffic-managing crossbar switch will be further described below by reference to FIG. 9.

However, in order not to obscure the illustration of FIG. 1 with unnecessary detail, only one pipeline 124 of the data plane circuit 110 is illustrated in FIG. 1. As shown, the pipeline 124 is formed by several message processing stages 130 that perform successive operations on a header vector 180 associated with a data message that the data plane circuit 110 receives. This header vector 180 in some embodiments is generated by a data plane parser, as further described below. In some embodiments, the header vector 180 for a data message includes the character string 182 stored in the data message, a current state 184 for each state machine implemented in the data plane, and one or more fields to store one or more pattern-identifying parameter sets 186 that identify one or more patterns identified in the character string 182 by the message processing stages 130 of the data plane circuit 110.

The message processing stages 130 are match-action unit (MAU) stages, each of which has one or more match engines 135 and one action engine 140 for each match engine, with the match engine 135 having a set of match tables 137. As further described below, one or more of the MAU stages 130 implement one or more state machines 145 by (a) comparing (1) the current state of the state machine and (2) portions of character strings, both stored in the header vectors, with records in the match tables 137, (b) adjusting the current state in the header vector based on this comparison, and (c) writing a pattern-identifying parameter set in a header vector each time the current state has been adjusted to a state that corresponds to an identified character pattern.

More specifically, the server 105 in some embodiments executes a compiler that compiles search character patterns into one or more state machines that are used to configure the MAU stages 130 of the data plane circuit 110. These message processing stages run at the message-process line rate of the data plane circuit to search for character patterns in the message payload data that match the patterns that are the subject of the search. As further described below, each state machine in some embodiments includes (1) several states comprising partial-pattern states and at least one full-pattern state, and (2) several transitions between the states, with each transition associated with a match of a set of characters in a data message and at least a portion of at least one pattern. The state machine transitions in some embodiments include at least one transition that is associated with a match of several characters in a data message with a multi-character portion of at least one pattern.

To configure the message processing stages 130, the compiler in some embodiments provides to the data plane circuit 110 configuration data that specifies records for match-action tables of the message processing stages. The compiler in some embodiments provides configuration data to the data plane circuit 110 through out-of-band communication (through a network) with a control plane circuit associated with the data plane circuit, and this control plane circuit then configures the data plane circuit based on the received configuration data. This control plane in some embodiments is a local control plane of the network element 115 of the data plane circuit 110, while in other embodiments it is a remote control plane operating on a device separate from the network element 115. In other embodiments, the compiler provides configuration data to the data plane circuit 110 through in-band communication, i.e., through data messages that the data plane circuit 110 receives through an intervening network and its physical ports and MAC (media access control) interface. In some of these embodiments, the data plane circuit 110 forwards the data payload of the in-band received messages to its local control plane, which, in turn, configures the data plane circuit 110.

The match-action records in the received configuration data in some embodiments configure one or more match engines 135 and the action engine 140 of the data plane circuit to implement the state machine 145. With this implemented state machine, the data plane circuit 110 can then search data messages to identify one or more character patterns in the data messages. For instance, in some embodiments, the configuration data specifies several match-action record pairs for the MAU stage 130 to store. Each match-action pair in some embodiments includes (1) a match parameter set that includes a first state of the state machine and a set of characters, and (2) an action parameter set that specifies a second state.

When a current state of the state machine 145 and an examined portion of a character string stored in a data message match the match parameter set of a particular match-action pair, the match-action unit that implements the particular match-action pair changes the current state of the state machine from the first state to the second state. In some embodiments, the set of characters of each match parameter set in a group of match parameter sets for a group of match-action pairs can include more than one character. For at least a subset of match parameter sets, some embodiments allow each particular character set in at least a subset of the character sets with more than one character to have at least one wildcard character that matches any potential character in a character portion that is being compared to the character set.

FIG. 1 shows one match engine 135 retrieving from a header vector 180 a current state 184 and a character string portion that is assigned to the match engine's MAU stage 130 to analyze. The match engine 135 then determines whether the current state 184 and the character string portion match at least one match parameter set of at least one match record in one of its match tables 137. If so, the match engine 135 identifies for the action engine 140 the highest priority matching record (e.g., the record in its match tables with the highest priority that has a match parameter set that is the same as the retrieved current state 184 and the character string portion), so that the action engine 140 can modify the current state 184 in the header vector 180 to a “next state” associated with this matching record, as shown in FIG. 1. In some embodiments, the matching records store their associated next state and the match engine 135 provides this next state to the action engine 140. In other embodiments, the next states associated with the match table records are stored in other tables, e.g., operand tables or action tables, from which the action engine 140 receives the next states for match engine records that match the analyzed current state and character string portion.

When the analyzed current state and the character string portion do not match the match parameter set of any match table records that specify a transition to a next state in the state machine from the current state, the state machine resets to its original state in some embodiments. For instance, in some embodiments, the match tables 137 of the match engine 135 in some embodiments have a default, lowest-priority match record that specifies that the next state as the first state of a state machine. This match record will match any current state and any character string portion to ensure that the match engine 135 can find one match record in any matching operation that it performs.

When the current state and character string portion of a matching operation does not match any other match table records, these two values will match the default rule, which then causes the action engine 140 to reset the state machine's current state to its first state, as further described below. Alternatively, when the match engine 135 matches a current state and a character string portion to a match table record that specifies a state that is associated with a last character of a searched pattern, the action engine 140 of the same MAU in some embodiments (or the next MAU in other embodiments) records in the header vector 180 a pattern-identifying parameter set 186 that includes (1) a location identifier identifying the location of the matching portion in the character string 182, (2) a pattern identifier identifying the pattern that was identified in the character string 182, and (3) a data message identifier to identify the data message that contained the identified character pattern. In some embodiments, the pattern identifier is an encoded value (e.g., an index to a lookup table), while in other embodiments the pattern identifier is the entire character pattern itself.

In some embodiments, the match tables 137 of a match engine 135 include a TCAM (ternary content addressable memory) and an SRAM (static random access memory). Some embodiments use the TCAM of a match-action unit to store match parameter sets with at least one wildcard character, while using the SRAM match tables to store match parameter sets that do not use wildcard characters. When the match engine 135 matches an analyzed character string portion to match parameter sets in the TCAM and SRAM match tables, the SRAM match parameter set in some embodiments is identified as the matching match parameter set. Also, when this engine matches the analyzed character string portion to several match parameter sets in the TCAM match table but not to an SRAM record, the match parameter set with a highest priority in the TCAM match table is identified as the matching match parameter set.

Some embodiments store a set of characters of a match parameter set in an SRAM memory in terms of the hash of the set of characters instead of storing the set of characters in order to reduce size of the SRAM match records. In these embodiments, the data plane circuit 110 is configured to compare several characters in a data message with a set of characters of a match parameter set by first generating a hash value of the data message characters and comparing the hash value with the hash of the set of characters that are stored in the match parameter set.

As shown in FIG. 1, the data plane pipeline 124 has a publisher 170 that either recirculates the data message, or sends one or more data messages to the server 105 to publish match parameter data that specifies one or more patterns identified in a character string of a data message, and the location of these identified characters. For each identified character pattern, the publisher 170 provides (1) a location identifier identifying the location of the matching portion in the character string 182, (2) a pattern identifier identifying the pattern that was identified in the character string 182, and (3) a data message identifier to identify the data message that contained the identified character pattern.

In some embodiments, the publisher 170 does not publish any identified character patterns to the server 105 until it has finished processing all of the characters in the character string that is stored in a data message. When one pass through the data plane pipeline 124 cannot process all of the characters in a character string of a data message, the publisher 170 recirculates the data message back to the start of this pipeline so that the configured pattern-identifying MAUs of this pipeline can continue analyzing the characters in this character strings until all of the characters have been examined. In other words, the data plane circuit 110 in some embodiments is configured to recirculate a data message when the data plane circuit 110 cannot check all the characters stored in the data message after having the data message traverse through one or more passes through the MAU stages 130 of the pipeline 124.

In some embodiments, the publisher 170 publishes (to the server 105) identified character patterns in a character string stored in a data message even when it is recirculating the data message so that the data plane can analyze other parts of the character strings that have yet to be processed. Also, in some embodiments, the publisher 170 drops a data message sent by the server 105 when the data message does not contain any patterns for which the data plane has been configured to search. Other embodiments, however, send to the server 105 a data message to identify one or more processed data messages from the server 105 that do not contain any of the searched patterns.

In the embodiments described above, the data plane circuit identified character patterns and for each identified character pattern provides to the server 105 (1) a location identifier identifying the location of the matching portion in the character string 182, (2) a pattern identifier identifying the pattern that was identified in the character string 182, and (3) a data message identifier to identify the data message that contained the identified character pattern. The data plane circuit in other embodiments, however, operates differently.

For instance, after identifying patterns in a data message, the data plane circuit in other embodiments simply returns the data message, or otherwise returns an identifier for the data message, to the server 105 in order to direct the server to process it further, or have another device process the data message further (e.g., to identify the pattern). In still other embodiments, the data plane circuit stores the data message in an external memory. The server 105 or another device can then retrieve the data message from the external memory and process it further. Storing data messages to external memory are further described in U.S. patent application Ser. No. 16/540,773, and incorporated herein by reference.

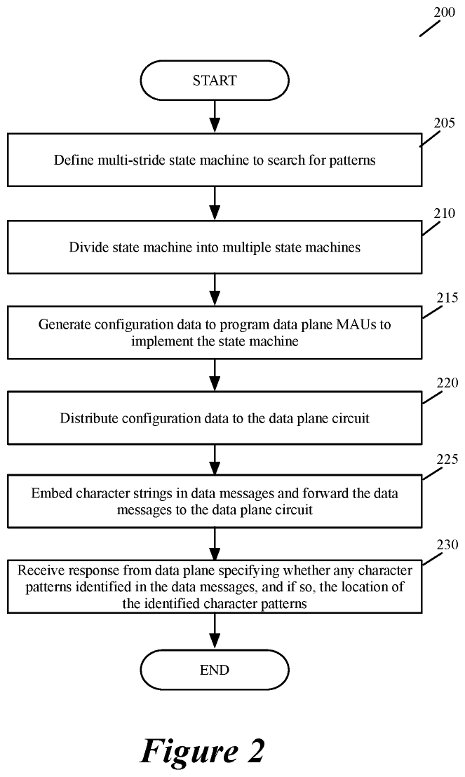

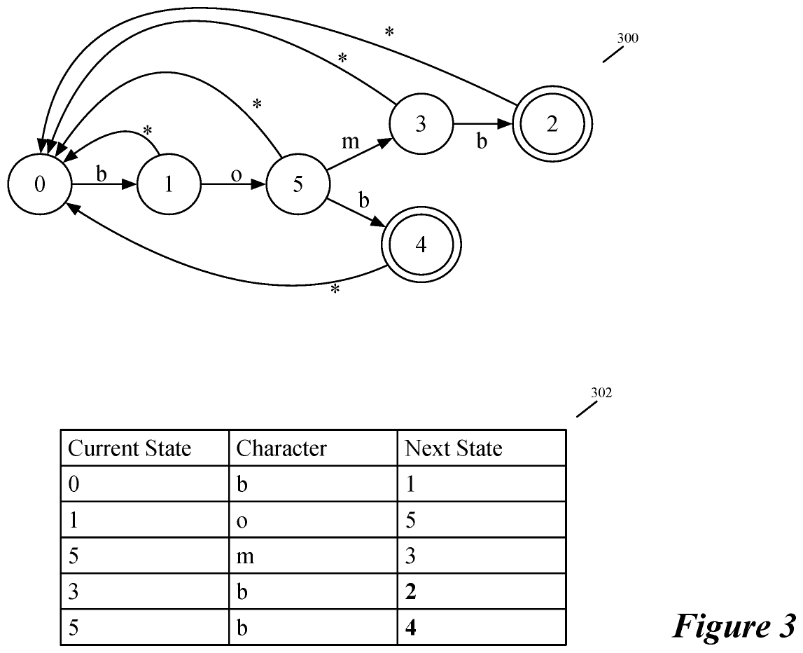

FIG. 2 illustrates a process 200 performed by the server 105 in some embodiments. As shown, the process 200 starts with the server defining (at 205) a multi-stride state machine to search for one or more character patterns. Before explaining a multi-stride state machine, a single-stride state machine will first be described by reference to FIG. 3. This figure illustrates a DFA state machine 300 for searching for “bomb” or “bob” in a string of characters, and a state-transition table 302 for specifying the match condition for transitioning from one state to another. In a single-stride string matching DFA, like the one shown in FIG. 3, every transition consumes a single character—the state machine is said to have a stride size of 1. For example, to match the pattern “bob”, the state machine 300 first searches for “b”, then “o” and then “b” To search a received set of characters, a search process uses the state machine 300 to traverse the states of this DFA while reading (consuming) one character at a time from the received input string.

When processing a portion of the string that contains “bob” that is in the middle of the received string between characters that are neither “b” nor “o”, the process starts at state 0 in the DFA. Upon consuming “b”, the search process transition to state 1. From there, the search process transitions to state 5 upon finding “o”, and then upon finding the next character to be “b”, transitions to state 4, which is an accepting state (also called a pattern-identified state) that signifies that the search process has found a matching string in the received set of characters. In FIG. 3 and other figures, each accepting state is represented by two concentric circles, while all other states are represented by one circle. As shown in FIG. 3, the search process returns to state 0 from each of the states 1, 5, 3, and 4 when the next character that it consumes is not the character needed to transition to a subsequent state. This figure shows these other characters as *.

Although a single-stride DFA (like DFA 300) is a compact representation of the patterns, it has limited throughput: each transition only consumes a single character. Consuming a single character per transition is a fundamental bandwidth limitation. By increasing the stride size, some embodiments can consume more characters per transition, resulting in fewer transitions to traverse the state machine. Some embodiments convert the single stride DFA into a k-stride DFA. With a k-stride DFA, each transition consumes k characters of the input string. Increasing k reduces the number of transitions to match a string, but comes at the expense of data structure memory usage: it increases the number of transitions. This is because each state needs a transition for any possible combination of the next k characters.

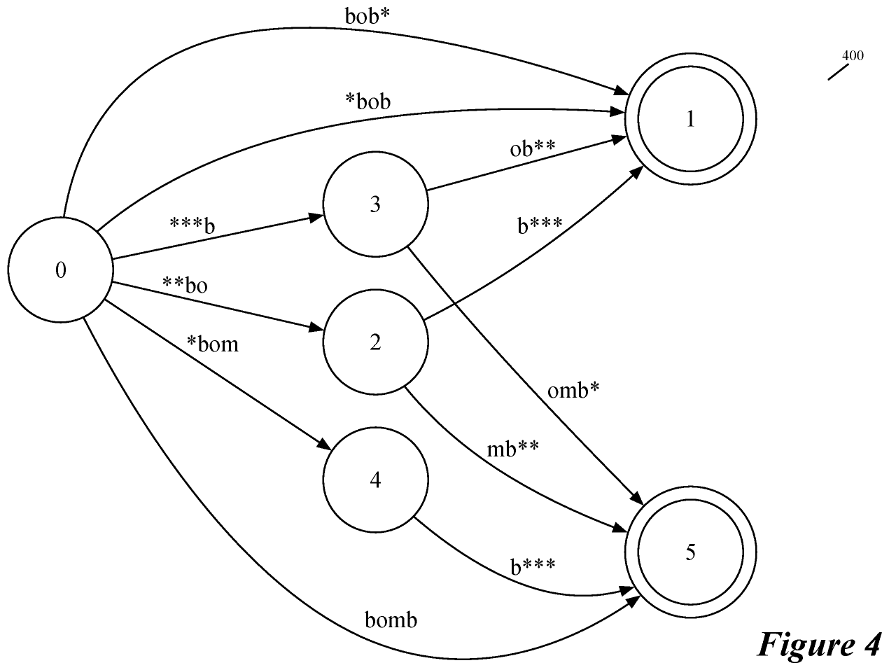

FIG. 4 shows a 4-stride DFA 400 for matching “bomb” or “bob”. In this example, the 4-stride DFA 400 results in five states and eleven transitions between the states. This number of transitions is more than twice that of the original 1-stride DFA 300 of FIG. 3. In FIG. 4, all the transitions are defined in terms of four characters. However, with the exception of the transition from state 0 to accepting state 5, all the transitions include one or more wildcard values “*”. Also, the state machine 400 transitions back to state 0 from any of its states when the next 4-stride character portion does not match a match pattern needed for the state machine to transition to a state other than its initial state 0. FIG. 4 does not show the transitions back to state 0 in order not to obscure the illustration in this figure with unnecessary detail.

When generating a DFA from multiple patterns, the similarity among the patterns affects the size of the DFA. If the patterns do not have any common characters, then the resulting DFA will have an independent path for each pattern. However, if the first characters of a pattern are present in another pattern, then the DFA needs transitions to account for the possibility of matching either pattern. This can dramatically increase the size of the DFA. As further described below, some embodiments utilize some optimizations to reduce the memory necessary to represent the DFA on the switch.

To compile multi-stride state machine to search for one or more patterns, some embodiments use the Aho-Corasick algorithm to create an NFA (a nondeterministic finite automaton) state machine from a set of exact patterns. Executing an NFA requires storing all possible current states in parallel while executing the state machine. Hence, to implement an NFA state machine, some embodiments store all such states. However, in other embodiments, storing all such states on an ASIC (such as the data plane circuit 110) might not be desirable, as it would require storing an arbitrary number of current states. Accordingly, the server 105 in some embodiments converts the NFA into a DFA, so that the data plane only has to keep track of the current state, but this comes at the expense of a larger state space.

To implement the state machine on the data plane, the compiler of the server 105 translates the DFA into a representation for the pipeline, namely state transition tables. Some embodiments use one or more of the following design choices to implement state transition tables in the data plane circuit 110 (1) replicate the transition table in each of several MAU stages, (2) using different types of memory in the MAUs for different types of match tables, and (3) breaking the DFA into several DFAs that are implemented in parallel by each of several MAUs.

Each of these design choices will now be further described. Instead of storing one big transition table, some embodiments replicate the transition table to each of all or several MAU stages in a data plane pipeline. This way, multiple transitions are performed per pass, increasing throughput by the number of stages (e.g., analyzing 96 characters in a 24 MAU-stage pipeline for a 4-stride DFA). According to this approach, given the current state and the current k input characters, each MAU stage specifies a transition to a next state or back to an initial state.

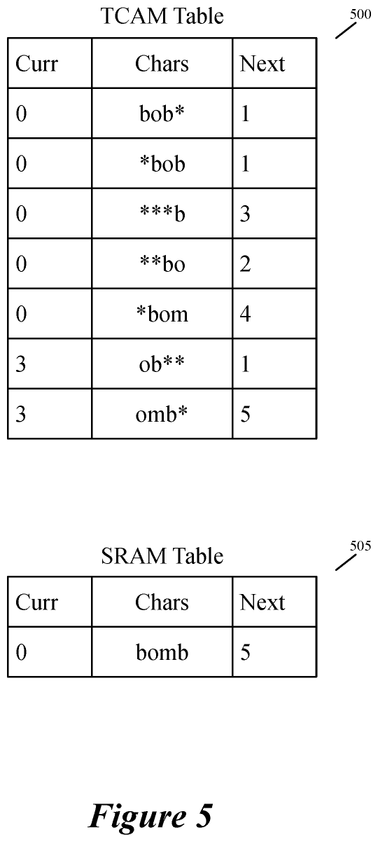

Some embodiments leverage different types of memory on the hardware. DFA transitions that consume exactly k characters require an exact match, which is stored in SRAM match tables. Transitions at the beginning or end of patterns match less than k characters, which requires ternary matching; these transitions are stored in TCAM. FIG. 5 illustrates the content of a TCAM match table 500 and an SRAM match table 505 that identify the next states for different combination of current states and string patterns for the example illustrated in FIG. 4.

In some embodiments, each message processing stage of the data plane circuit is configured to implement at least one state machine, and has two match tables, an SRAM match table and a TCAM match table. In some of these embodiments, the SRAM table is first applied, and if it misses, then the TCAM table is applied. In other embodiments, the TCAM and SRAM match tables are processed in parallel, but when a current string pattern matches multiple records in the same table or in both tables, the higher priority record is used to identify the next state. For instance, when one set of characters in a data message matches match parameter sets in the TCAM and SRAM match tables, the SRAM match parameter set in some embodiments is identified as the matching match parameter set, and the current state in the header vector is set to the next state identified in this SRAM record.

When one set of characters in a data message matches several match parameter sets in the TCAM match table, the match parameter set with the highest priority in the TCAM match table is identified as the matching match parameter set, and the current state in the header vector is set to the next state identified in this SRAM record. In some embodiments, the default match record in the TCAM record has a match parameter set that is set to all the match parameter sets being wild card values, and defines its next state as the first state of the DFA. This record ensures that the MAU returns the state machine to its initial state when the current character string that it examines does not match any match records that would advance the state machine to another non-initial state.

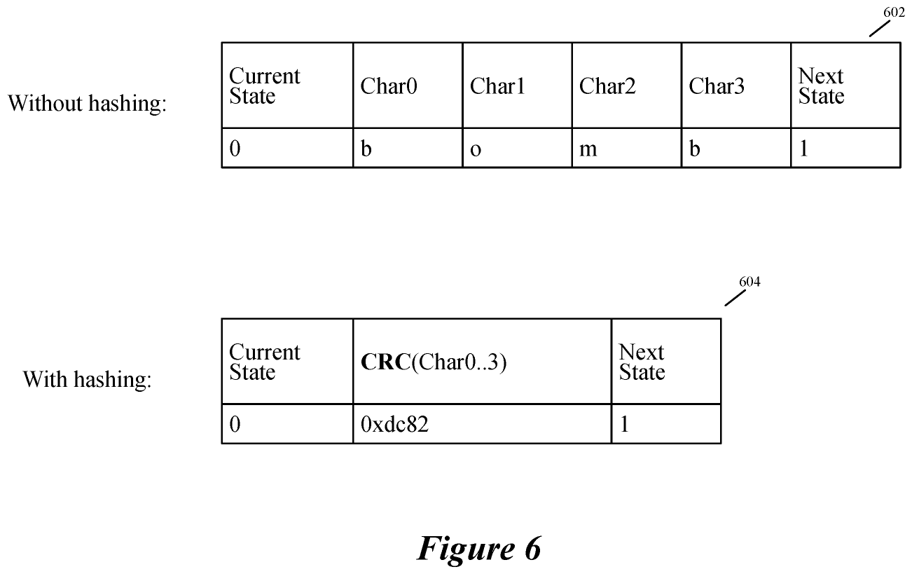

In some embodiments, the exact transition table (e.g., implemented in an SRAM) matches each individual character in the stride size, k. That means that the table needs to store k bytes per transition. To reduce memory usage, some embodiments generate a hash (e.g., a CRC16 hash) of the k characters, which is read by the exact match tables (e.g., the SRAM tables). It is possible to have hash collisions here. To illustrate this, FIG. 6 illustrates two examples of exact-match records in two different SRAM match tables. The first example is an exact-match record 602 in an SRAM match table that stores each individual character in a 4-stride string “bomb”, while the second example is an exact-match record 604 in an SRAM match table that stores a CRC encoded hash of bomb. To store bomb, the exact-match record 602 needs to consume four bytes, while the exact-match record 604 only needs to consume two bytes.

Hash collisions can occur. When generating the configuration data to configure the data plane circuit to search for one or more sets of characters, the compiler of some embodiments detects hash collisions (e.g., when two different transitions out of the same stage have the same hash), specifies a different hash function (CRC with a different polynomial) that does not produce collisions, and configures the data plane circuit to use this hash function. Hash collisions can also happen at runtime, which would produce false positives. For many applications, this is not a problem. But for the applications that cannot tolerate hash collisions, some embodiments have the server 105 catch false positive when this is feasible, and when not, reduce the number of searched patterns and/or avoid the hashing schemes.

After defining (at 205) the multi-stride state machine, the process 200 of the server 105 divides (at 210) the state machine into multiple state machines that can be executed in parallel by the MAU stages 130 of the data plane pipeline 124. Breaking the DFA defined at 205 into smaller DFA is one technique that some embodiments use to reduce the memory usage. In some embodiments, each of the smaller DFAs searches for a different set of character patterns, which in some embodiments can include more than one pattern. Some embodiments split the original DFA into smaller DFAs by partitioning the patterns into multiple subsets and constructing a DFA from each subset of patterns. The aggregate size of these smaller DFAs is smaller than that of one large DFA containing all the patterns. This is because, as described above, patterns with similarities can cause an explosion in the number of transitions.

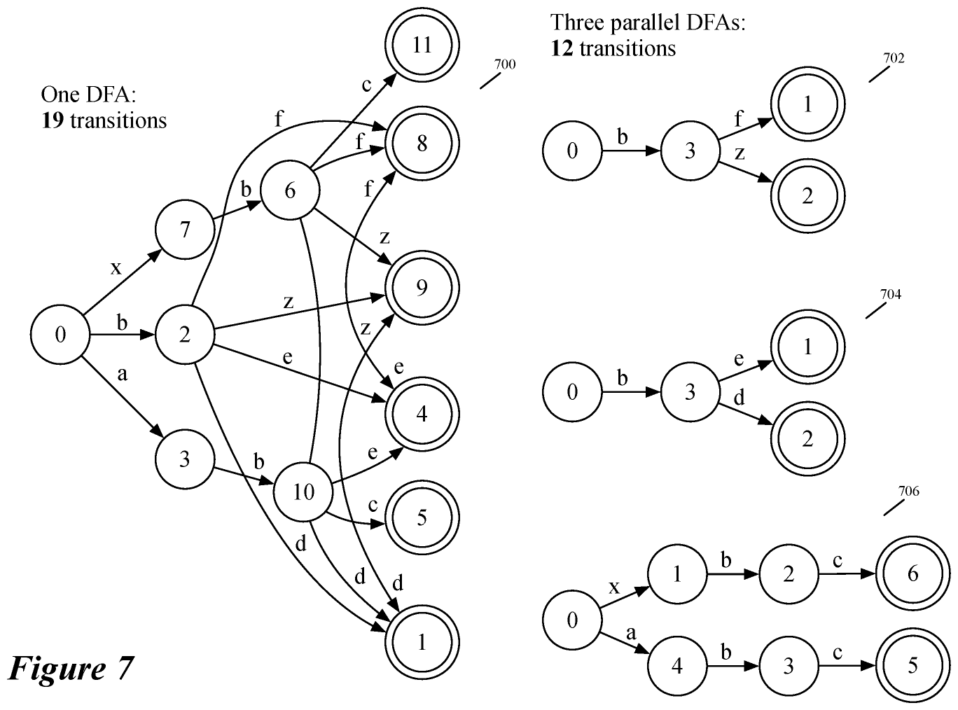

FIG. 7 illustrates an example of splitting one large DFA 700 into multiple smaller DFAs 702-706 in order to reduce the amount of resources consumed (e.g., the memory used) to perform the stateful tracking of patterns. In this example, an original DFA 700 with nineteen transitions is replaced with three smaller DFAs 702, 704 and 706 with a combined twelve transitions. To simplify the illustration in this example, arbitrary patterns are used in this example, and each of the transitions is shown to be a single stride transition. One of ordinary skill will realize that splitting DFAs is used in some embodiments that employ larger stride transitions (e.g., k-stride, with k being larger than 1).

In some embodiments, each of the smaller DFAs 702-706 is implemented by each MAU stage that examines different portions of a character string stored in a data message to identify one or more patterns of characters in the overall character string. In some embodiments, each such MAU stage uses a parallel set of resources (e.g., several parallel executing match engines 135 and action engines 140) to implement the three smaller DFAs 702-706. The twelve state transitions of the three smaller DFAs 702-706 consume less SRAM memory than the nineteen state transitions of the original DFA 700. For instance, in some embodiments, the twelve transitions consume only twelve SRAM records in three parallel match table SRAMs in each message-processing stage, while the nineteen transitions consume nineteen SRAM records in one match-table SRAM in each message-processing stage.

Some embodiments use an optimization process to find an optimal partitioning of the patterns to obtain a set of DFAs with the smallest aggregate size. Other embodiments partition the patterns randomly, and this approach has been found to produce DFAs that are small enough in practice. Increasing the number of partitions decreases the total number of transitions, and in turn SRAM and TCAM entries. Dividing an original DFA into smaller DFAs in some embodiments more dramatically reduces the number of SRAM entries than TCAM entries. Some embodiments chose to implement 3 parallel DFAs in the data plane circuit because in some data plane architectures, it is the most number of splits before the returns diminish.

After producing (at 210) the smaller DFAs, the process 200 generates (at 215) configuration data to program the data plane MAUs to implement the state machine. In some embodiments, the generated configuration data provides the match-table records needed to configure the SRAM and TCAM match tables of the data plane circuit 110 to specify the state transitions necessary for implementing the state machine. Also, in some embodiments, the configuration data configures the action engine 140 of the MAU stages 130 of the data plane circuit 110 to defining the current state 184 and pattern-identifying parameter sets 186 in the header vector 180. It also configures the publisher 170 to publish pattern-identifying parameter sets when the character strings are analyzed and to recirculate the data messages through the data plane when the portions of the character strings remain for analysis. In some of the embodiments that, instead of storing characters in the exact match table, store hash values of the characters as the match parameter values of the match records, the configuration data also specifies the hash function that the match engines should use to generate a hash value from the character portion that they analyze in the character string, so that this hash value can be compared to the match records in the exact match table (e.g., the SRAM table).

After generating (at 215) the configuration data, the process 200 distributes (at 220) the configuration data. As mentioned above, the server in some embodiments provides configuration data to the data plane circuit through out-of-band communication with a local or remote control plane circuit associated with the data plane circuit, and this control plane circuit then configures the data plane circuit based on the received configuration data. In other embodiments, the server provides configuration data to the data plane circuit through in-band communication, i.e., through data messages that the data plane circuit receives through its physical ports and MAC (media access control) interface. In some of these embodiments, the data plane circuit forwards the data payload of the in-band received messages to its local control plane, which, in turn, configures the data plane circuit.

After sending (at 220) the configuration data to the data plane (and receiving confirmation that the data plane has been configured, in some embodiments), the server 105 embeds (at 225) one or more character strings in one or more data messages, and then forwards the data messages to the data plane circuit 110 for processing. In some embodiments, the server 105 embeds the character strings in an encapsulating Ethernet/IP/UDP header with a special character-string header for storing the character string for processing. In some embodiments, this header includes (1) a layer 4 port (e.g., UDP source port) value that specifies that the data message contains a character string to analyze, and (2) an option field that stores character string. In other embodiments, another header is placed after a UDP header, and this other header contains the character string. In still other embodiments, the character string is placed in a header after the Ethernet header. Also, in some of the above-described embodiments, the data messages from the server 105 or other machines have header fields for storing pattern-identifying parameters.

In other embodiments, the server 105 embeds the character strings in the payloads of the data messages. In some of these embodiments, the data plane is configured to identify the location of the character strings in the payloads. Also, in some embodiments, the data messages that the server 105 streams to the data plane circuit 110 have header values (e.g., five tuple header values (source and destination IP address, source and destination port, and protocol) or source port/IP addresses) that identify the data messages as messages that contain character strings for the data plane to analyze for specific character patterns for which the data plane has been configured to search.

Last, at 230, the server 105 receives one or more data messages from the data plane circuit 110 to specify whether the data plane circuit 110 was able to identify one or more configured character patterns in the character strings embedded in the data messages sent at 225. As mentioned above, when the data plane circuit 110 identifies one or more configured character patterns in the embedded character string, the data plane returns in the header or payload of one or more data messages a pattern-identifying parameter set for each identified pattern, which, in some embodiments, includes (1) a data message identifier identifying the data message that contained the identified character pattern, (2) a location identifier identifying the location of the identified pattern in the character string embedded in the identified data message, and (3) a pattern identifier identifying the pattern. In some embodiments, the pattern identifier is an encoded value (e.g., an index to a lookup table), while in other embodiments the pattern identifier is the entire character pattern itself. After 230, the process 200 ends.

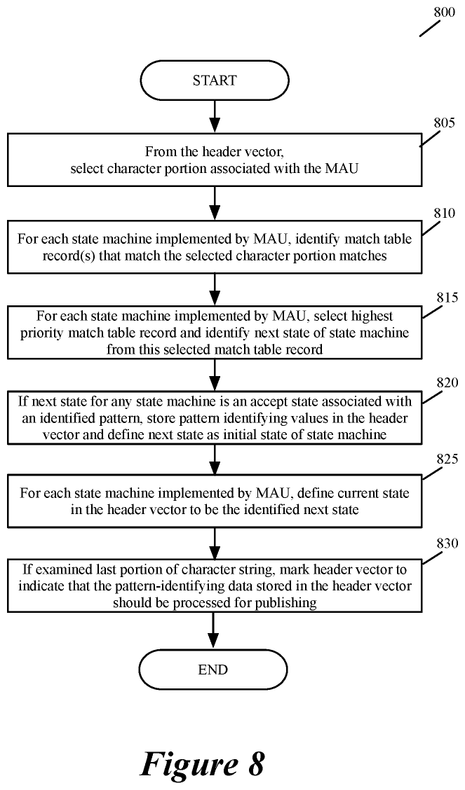

FIG. 8 illustrates a process 800 that each pattern-identifying MAU stage 130 of the data plane circuit 110 performs in some embodiments. As mentioned above, each such MAU stage 130 in some embodiments uses a parallel set of resources (e.g., several pairs of match engines 135 and action engines 140 that operate in parallel) to implement the multiple state machines (such as smaller DFAs 702-706) in parallel. The process 800 is performed by the pattern-identifying MAU each time the MAU receives a header vector of a data message that contains a character string to analyze.

From the received header vector, the MAU initially selects (at 805) a character string portion that is associated with the MAU. In some embodiments, different portions of the character string 182 in the header vector 180 are assigned to different MAU stage 130 for analysis. Hence, at 805, the process 800 selects the character string portion associated with its MAU. At 805, the process also retrieves the current state stored in the received header vector 180.

Next, at 810, the match-action engine pairs of the MAU compare the retrieved current state and character string portion with match-parameter sets of their match-table records to identify one or more matching records (e.g., to identify match-table records that have match parameter sets that are the same as the retrieved current state and character string portion). In some embodiments, each such match-table record identifies a next state, as shown in FIG. 5. Also, each match-action engine pair implements a different state machine in some embodiments. Hence, in identifying match-table records that match the retrieved current state and character string portion, each match-action engine identifies a next state to which the match-action engine's associated state machine should transition.

When a match-action engine pair identifies multiple match-table records that match the retrieved current state and character string portion, the match engine selects (at 815) the highest priority matching record for its action engine. If the match engine matches the retrieved current state and character string portion, the match engine selects (at 815) this matching record. As mentioned above, each match engine in some embodiments uses a TCAM match table to store match parameter sets with at least one wildcard character, while using an SRAM match table to store match parameter sets that do not use wildcard characters. When the match engine 135 matches an analyzed character string portion to match parameter sets in the TCAM and SRAM match tables, the SRAM match parameter set in some embodiments is identified as the matching match parameter set. Also, when this engine matches the analyzed character string portion to several match parameter sets in the TCAM match table but not to an SRAM record, the match parameter set with the highest priority in the TCAM match table is identified as the matching match parameter set.

As described above, the SRAM match table in some embodiments stores a set of characters of a match parameter set in terms of the hash of the set of characters instead of storing the set of characters in order to reduce size of the SRAM match records. In these embodiments, each match engine first generates a hash of the retrieved character string portion, and then compares this hash value with the hash values that the SRAM match records specify in their match parameter sets. Also, in some embodiments, the match table records of each state-machine implementing MAU contains a default, lowest-priority match record that specifies the next state as the first state of the state machine. This match record will match any current state and any character string portion to ensure that the match engine 135 can find one match record in any matching operation that cannot match the retrieved character string portion and current state to any other match table record.

Next, at 820, the action engine 140 records in the header vector a pattern-identifying parameter set 186 when the next state identified in the identified matching record is an accept state (i.e., is a state that is associated with a last character of a searched pattern) of the action engine's state machine, and then defines the next state of the state machine as an initial state of the state machine. In some embodiments, the match table record associated with an accept state has an associated parameter configured in a parameter memory of the MAU, and this parameter informs the action engine 140 that the next state identified by the match-table record identified by the match engine 135 is an accept state.

At 825, the action engine 140 of each match-action engine pair then modifies the current state for its state machine in the header vector 180 to (1) a next state identified by the highest priority matching record selected (at 815) by its corresponding match engine 135 when the next state is not an accept state of the state machine, or (2) a next state that is the initial state of the state machine when the next state specified by the selected highest priority matching record is an accept state. Lastly, at 830, the action engine 140 records a value in the header vector to indicate that the pattern-identifying parameter data 186 that is stored in this header vector is ready for publishing, when the action engine belongs to the MAU stage 130 that examined the last portion of the character string 182 that was stored in the header vector. This designation in some embodiments directs a deparser of the data plane to process this header vector for publishing, as described above and further described below. After 830, the process ends.

FIG. 9 illustrates an example of a forwarding element 900 with a data plane circuit 110 that can be configured to implement one or more state machines that can search character strings stored in the data messages that the data plane circuit processes. The forwarding element 900 forwards data messages within a network 910. The forwarding element 900 can be any type of forwarding element, such as a switch, a router, a bridge, etc. In FIG. 9, the forwarding element is deployed as a non-edge forwarding element in the interior of the network to forward data messages between machines 905a and 905b. In other cases, the forwarding element 900 is deployed as an edge forwarding element at the edge of the network to connect to compute devices (e.g., standalone or host computers) that serve as sources and destinations of the data messages.

As a non-edge forwarding element, the forwarding element 900 forwards data messages between forwarding elements in the network (i.e., through intervening network fabric 910). As an edge forwarding element, the forwarding element forwards data messages to and from edge compute devices to each other, to other edge forwarding elements, and/or to non-edge forwarding elements. Also, in some embodiments, the data plane circuit 110 can be part of another type of appliance, e.g., one that just analyzes character strings in data messages to identify configured patterns, as mentioned above by reference to FIG. 1. In some embodiments, the data plane circuit 110 is configured to search character strings in the data messages as it forwards the data messages between two devices 905a and 905b. In other embodiments, the data plane circuit 110 is configured to search character strings in the data messages sent by the server 105, while forwarding other data messages exchanged between other devices 905.

As shown, the forwarding element 900 not only includes the data plane circuit 110 to perform the forwarding operations of the forwarding element 900 to forward data messages received by the forwarding element to other devices, but also includes a control plane circuit 925 (the “control plane 925”) that configures the data plane circuit 110. The forwarding element 900 also includes physical ports 912 that receive data messages from, and transmit data messages to, devices outside of the forwarding element 900.

In some embodiments, the control plane 925 configures the data plane 110 to perform its message forwarding and pattern-identifying operations. For the pattern-identifying operations, the control plane 925 in some embodiments receives from the server 105 configuration data through out-of-band communications that traverse the intervening network fabric 910. In some embodiments, the control plane includes (1) one or more processors (such as a microprocessor with multiple processing cores or units) that execute instructions, and (2) a memory that stores instructions for processes that when executed by the processors perform the control plane operations. These instructions can be specified by (1) a manufacturer of the network forwarding element 900 that includes the control and data planes (925 and 110), (2) a network administrator that deploys and maintains the network forwarding 900, or (3) one or more automated processes that execute on servers and/or network forwarding elements that monitor network conditions. The control plane processor, or another circuit of the control plane, communicates with the data plane (e.g., to configure the data plane or to receive statistics from the data plane) through a control/data plane interface (not shown).

The data plane circuit 110 includes ports 915 that receive data messages to process and transmit data messages after they have been processed. Some ports 915 of the data plane 110 are associated with the physical ports 912 of the forwarding element 900, while other ports 915 are associated with other modules of the data plane 110. For instance, in some embodiments, one or more ports 915 are recirculation ports that recirculate a data message that is processed by an egress pipeline 942 back to an ingress pipeline 940. The data plane 110 also includes message generators 935, multiple ingress pipeline stages 940, multiple egress pipeline stages 942, and a traffic manager 944. In some embodiments, the data plane is implemented on an application specific integrated circuit (ASIC), and its components are defined on this integrated circuit.

The message generators generate messages in the data plane. In some embodiments, these messages can direct circuits in the data plane to perform certain operations or to store data in the messages for export to the control plane or to another device through a network. The ingress and egress pipelines process the data messages received by the forwarding element in order to forward these messages to their destinations in the network. The traffic manager 944 in some embodiments includes a crossbar switch that directs messages from the ingress pipelines to egress pipelines.

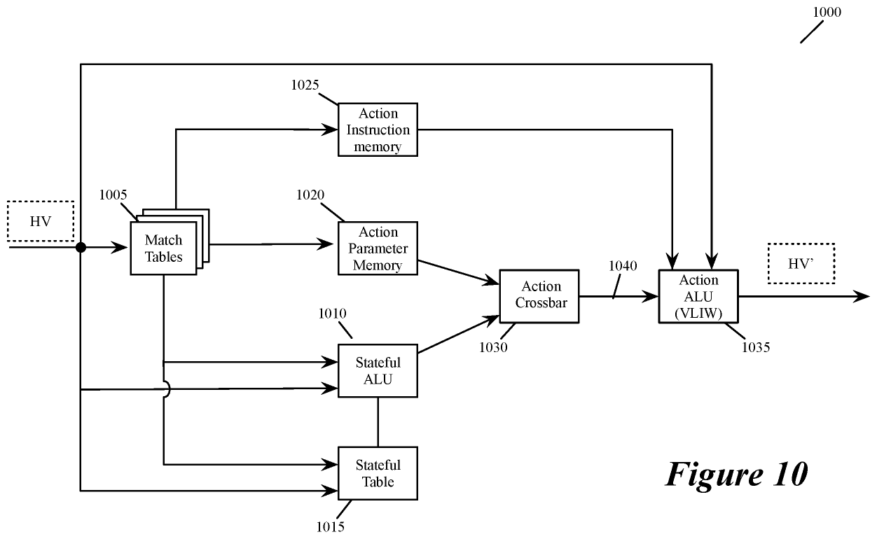

Each ingress or egress pipeline includes several configurable (i.e., programmable) MAU stages 130 that are configured to perform the data-plane forwarding operations of the forwarding element 900 to process and forward data messages to their destinations. These message-processing stages perform these forwarding operations by processing header vectors (e.g., message headers) associated with data messages received by the data plane 110 in order to determine how to forward the messages. As described above and further described below by reference to FIG. 10, an MAU is a circuit in some embodiments that includes match tables that store multiple records for matching with data tuples (e.g., header vectors) of the processed data messages. When a data message matches a match record, the MAU then performs an action specified by an action record associated with the identified match record (e.g., an action record that is identified by the identified match record).

In some embodiments, an MAU also includes a set of stateful ALUs (e.g., four ALUs) that perform arithmetic operations based on parameters specified by the header vectors and/or the match tables. The ALUs can store the result of their operations in stateful tables that they access and/or can write these results in the header vectors (e.g., directly, or by directing another action ALU to write these results in the header vectors) for other MAU stages to process.

In addition to the MAU stages, each ingress or egress pipeline includes a parser 930 and a deparser 934. A pipeline's parser 930 extracts a message header from a data message that the pipeline receives for processing, and puts this extracted header in a header vector (HV) format that is processed, and in some cases modified, by successive message processing stages 130 as part of their message processing operations. The parser 930 of a pipeline passes the payload of the message to the deparser 934 as the pipeline's message-processing stages 130 operate on the header vectors. In some embodiments, the parser also passes the message header to the deparser 934 along with the payload (i.e., the parser passes the entire message to the deparser).

At the end of the ingress pipeline, the header vector for a message is combined with the message payload, and the combined message is provided to the traffic manager (TM). Based on the ingress side processing, and the header designations of the message, the traffic manager 944 in some embodiments places the message in a TM egress queue (not shown) that is associated with the egress pipeline 942 designated for the continued processing of the data message. From this TM egress queue, the data message passes to its corresponding egress pipeline 942, which has its parser 930 separate the message into its payload and header vector, pass the payload (or entire message) along a bypass path to the deparser 934 of the pipeline and pass the header vector to the first MAU stage 130 of the pipeline.

As shown in FIG. 9, each of several or all of the MAU stages 130 are configured to implement several state machines 145 in parallel, in order to analyze character strings embedded in a subset of data messages processed by the data plane to identify patterns for which these MAUs have been configured to detect. FIG. 9 shows each state machine being implemented by a pair of match and action engines 135 and 140. As mentioned above, the local control plane 925 in some embodiments configures the data plane circuit 110 to perform its pattern-identifying operations based on configuration data generated by the server 105. In other embodiments, a remote control plane configures the data plane circuit 110 to implement its pattern-identifying operations based on configuration data generated by the server 105. A remote control plane is implemented in some embodiments by a control software layer executed by one or more CPUs of another forwarding element or a remote computer (e.g., server).

When the egress pipeline 942 finishes processing the header vector for the data message, the deparser 934 of the egress pipeline 942 produces the data message header from the message's header vector that was processed by the pipeline's last message processing stage, and combines this header with the data message's payload. In some embodiments, the deparser 934 uses part of the header received form the parser 930 to reconstitute the message from its associated header vector. When the data message does not contain a character string for the data plane to search and it is just processed by the data plane for forwarding to its next hop, the deparser 934 provides the data plane port 912 associated with the next hop.

When the header vector specifies that it stores a character string that has not yet been fully analyzed by the data plane implemented state machines, the deparser 934 of the egress pipeline directs the reconstituted message to a data plane port #112 that recirculates the data messages back to the parser of the ingress pipeline so that the character string in the data message can be further processed. On the other hand, the deparser processes the data message differently when the header vector specifies that it stores a character string that has been fully analyzed. For instance, in the embodiments that have the data plane circuit search data messages for character patterns as the data messages traverse between source and destination devices 905a and 905b, the egress pipeline deparser provides the data to a recirculation port 912 to recirculate back to an ingress pipeline so that it can be processed for forwarding to its next hop and it can be replicated by the traffic manager with the replicated copy being addressed and forwarded to the server 105.

On the other hand, in the embodiments that have the data plane circuit 110 search data messages sent from the server 105, the deparser 934 recirculates that data message back to its ingress pipeline's parser 930 so that the ingress or egress pipeline can modify the header of the data message (e.g., the source and destination IP and port addresses) before the deparser 934 then sends out the data message back to the server 105 with the pattern-identifying parameters embedded in the data message. In some embodiments, the deparser recirculates the data message back to an ingress pipeline for processing for publication based on an MAU stage marking the header vector to specify that its stored character string has been fully analyzed.

FIG. 10 illustrates a match action unit 1000 of some embodiments. As mentioned above, an ingress pipeline 940 or egress pipeline 942 in some embodiments has several MAU stages 130, each of which includes message-processing circuitry for forwarding received data messages and/or performing stateful operations based on header vectors associated with the data message. In some embodiments, the control plane 125 of the forwarding element 100 or a remote control plane configures the MAU stages 1000 of the data plane 120 to implement not only the forwarding operations of these MAU stages, but also the pattern-identifying operations that some of the MAU stages 1000 perform. These operations are performed by processing values stored in the header vectors that are generated for the data messages.

In some embodiments, each message processing stage 130 of the data plane 110 has several (e.g., four) MAUs 1000 operating in parallel on the same header vector that is received from the parser 130 or from a previous message processing stage 130. In some of these embodiments, two or more of these MAUs in the same stage 130 implements two or more state machines that operate in parallel to identify two or more sets of patterns in character strings stored in the processed header vector for a data message received by the data plane circuit. The parallel-operating MAUs 1000 of each stage 130 analyze the same character-string portion (i.e., the same portion of a character string stored in a data message) that the stage is configured to analyzed. The match-action unit 1000 in some embodiments processes a different header vector on every clock cycle, thus ensuring that it operates synchronously with the dataflow of the message-processing pipeline.

As shown, the MAU stage 1000 in some embodiments has a set of one or more match tables 1005, a stateful ALU 1010, a stateful table 1015, an action crossbar 1030, an action parameter memory 1020, an action instruction memory 1025, and an action ALU 1035. The match table set 1005 can compare one or more fields in a received message's header vector to identify one or more matching flow entries (i.e., entries that match the message's HV). As mentioned above, the match table set 1005 in some embodiments includes TCAM table and an exact match SRAM table. In some embodiments, the match table set can also include one or more tables that can be accessed at an address that (1) is a value extracted from one or more fields of the message's header vector, or (2) is a hash of this extracted value. In some embodiments, the local control plane, or a remote control plane, supplies flow entries (e.g., the flow-match identifiers and/or action identifiers) to store in one or more match tables and associated action tables.

In some embodiments, the value stored in a match table record that matches a message's flow attributes, or that is accessed at a hash-generated address from one or more message flow attributes, provides addresses of records to access and process in the action parameter memory 1020 and action instruction memory 1025. Conjunctively or alternatively, a match table record in some embodiments has an associated record in the action instruction memory and/or an associated record in the action parameter memory that specifies an action instruction to execute and/or an action parameter to process.

The actions performed by the MAU stage 1000 can include actions that the forwarding element has to perform on a received data message to process the data message (e.g., to drop the message, or to forward the message to its destination machine or to other intervening forwarding elements). These actions in some embodiments also include actions associated with the pattern-identifying operations of the data plane, such as modifying the value 184 of the current state in the header vector, storing pattern identifying parameters 186 in the header vector, etc.

The stateful ALUs 1010 in some embodiments allow the data plane to perform one or more stateful operations, while stateful tables 1015 store state data used and generated by the stateful ALU 1010. In some embodiments, the value stored in a match table record that matches a message's flow identifier, or that is accessed at a hash-generated address, can provide an address and/or parameter for one or more records in the stateful table 1015, and can provide an instruction and/or parameter for the stateful ALU 1010.

As shown, the stateful ALU 1010 and the stateful tables 1015 also receive a processed message's header vector. The header vectors can include instructions and/or parameters for the stateful ALU, while containing addresses and/or parameters for the stateful tables 1015. In some embodiments, the stateful ALUs perform operations synchronously with the data flow of the message-processing pipeline (i.e., synchronously at the data line rate of the data plane 120). In some embodiments, the local or remote control plane provides configuration data to program the stateful ALUs 1010 of the MAUs 1000 of the data plane 120.

The stateful ALU 1010 outputs an action parameter to the action crossbar 1030. The action parameter memory 1020 also outputs an action parameter to this crossbar 1030. The action parameter memory 1020 retrieves the action parameter that it outputs from its record that is identified by the address provided by the match table set 1005. The action crossbar 1030 in some embodiments maps the action parameters received from the stateful ALU 1010 and action parameter memory 1020 to an action parameter bus 1040 of the action ALU 1035. This bus provides the action parameter to this ALU 1035. For different data messages, the action crossbar 1030 can map the action parameters from the stateful ALU 1010 and the action parameter memory 1020 differently to this bus 1040. The crossbar can supply the action parameters from either of these sources in their entirety to this bus 1040, or it can concurrently select different portions of these parameters for this bus.

The action ALU 1035 also receives an instruction to execute from the action instruction memory 1025. This memory 1025 retrieves the instruction from its record that is identified by the address provided by the match table set 1005. The action ALU 1035 also receives the header vector for each message that the MAU processes. Such a header vector can also contain a portion or the entirety of an instruction to process and/or a parameter for processing the instruction.

The action ALU 1035 in some embodiments is a very large instruction word (VLIW) processor. The action ALU 1035 executes instructions (from the instruction memory 1025 or the header vector) based on parameters received on the action parameter bus 1040 or contained in the header vector. The action ALU stores the output of its operation in the header vector in order to effectuate a message forwarding operation and/or stateful operation of its MAU stage 1000. The output of the action ALU forms a modified header vector (HV′) for the next MAU stage or the deparser. In some embodiments, examples of such actions include (1) changing the current state value 184, and (2) storing the pattern identifying parameters 186 in the header vector. In some embodiments, the parallel-operating MAUs 1000 of the same MAU stage 130 write these values to different parts of the header vector.

In other embodiments, the match tables 1005 and the action tables 1015, 1020 and 1025 of the MAU stage 1000 can be accessed through other methods as well. For instance, in some embodiments, each action table 1015, 1020 or 1025 can be addressed through a direct addressing scheme, an indirect addressing scheme, and an independent addressing scheme. The addressing scheme that is used depends on the configuration of the MAU stage, which in some embodiments, is fixed for all data messages being processed, while in other embodiments can be different for different data messages being processed.

In the direct addressing scheme, the action table uses the same address that is used to address the matching flow entry in the match table set 1005. As in the case of a match table 1005, this address can be a hash generated address value or a value from the header vector. Specifically, the direct address for an action table can be a hash address that a hash generator (not shown) of the MAU generates by hashing a value from one or more fields of the message's header vector. Alternatively, this direct address can be a value extracted from one or more fields of the header vector.

On the other hand, the indirect addressing scheme accesses an action table by using an address value that is extracted from one or more records that are identified in the match table set 1005 for a message's header vector. As mentioned above, the match table records are identified through direct addressing or record matching operations in some embodiments.

The independent address scheme is similar to the direct addressing scheme except that it does not use the same address that is used to access the match table set 1005. Like the direct addressing scheme, the table address in the independent addressing scheme can either be the value extracted from one or more fields of the message's header vector, or it can be a hash of this extracted value. In some embodiments, not all the action tables 1015, 1020 and 1025 can be accessed through these three addressing schemes, e.g., the action instruction memory 1025 in some embodiments is accessed through only the direct and indirect addressing schemes. Also, other addressing schemes are used to address some of the tables (e.g., action tables).

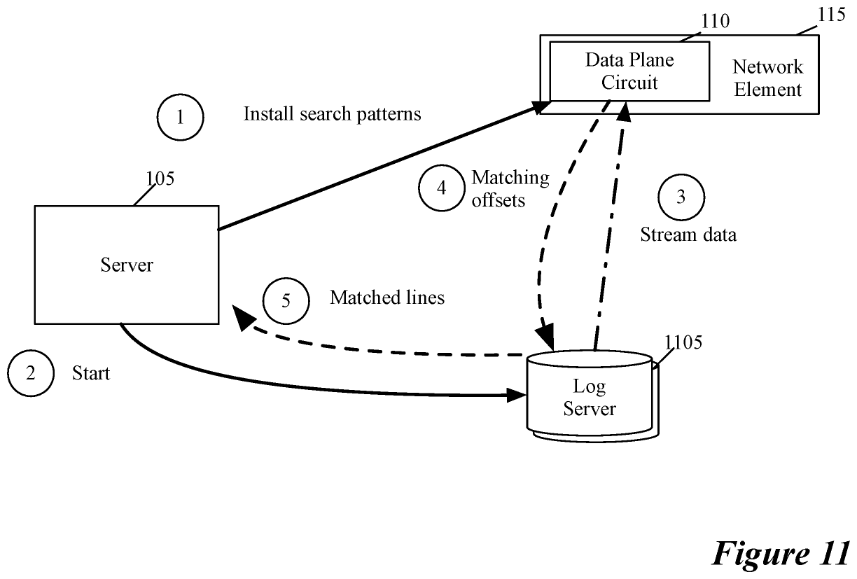

FIG. 11 illustrates an alternative system for using the data plane 110 to search of patterns. This system 1100 includes the server 105, the network element 115 and the data plane circuit 110, but it also includes a cluster of one or more log servers 1105 that stores several character strings for searching. In this system, the server 105 configures the data plane circuit 110 to identify one or more character patterns, as before. However, unlike the system of FIG. 1, the system 1100 of FIG. 11 has the server 105 direct the log server cluster 110 to send data messages that store the character strings to the data plane circuit 105. The data plane circuit 105 then provides the results of its searching (e.g., in term of pattern-identifying parameters that identify the pattern, the location of the pattern in a character string and the data that contains the character string) to the log server cluster 1105, which then provides these results to the server 105.

While the invention has been described with reference to numerous specific details, one of ordinary skill in the art will recognize that the invention can be embodied in other specific forms without departing from the spirit of the invention. For instance, the above-described embodiments store pattern-identifying parameters 186 in the header vectors 180, before publishing data messages based on these header vectors and addressing these data messages to the server 105. Other embodiments, however, store the pattern-identifying parameters in stateful ALU tables 1015 of one or more MAUs until the MAUs have analyzed the entirety of one or more character strings stored in one or more data-plane processed data messages. Once the set of one or more character strings have been analyzed, some of these embodiments read the stored pattern-identifying parameters from the stateful ALU tables and store these parameters in one or more data messages that are sent to the server 105.

In some of the embodiments described above, the parser 930 removes the character string from a data message (e.g., a message sent from the server 105) in its entirety and stores this character string in the header vector 180. In other embodiments, when the entire character string cannot be processed in one pass through the data plane, the parser only extracts the portion of the character string that can be processed in one pass through the data plane and stores only this extracted portion in the header vector. For each subsequent pass through the data plane, the parser then extracts from the data message other portions of the character string to process in the subsequent pass. Also, in some embodiments, the character strings are stored partially or fully in the payload of the data messages. In these embodiments, the data plane performs deep packet inspection to remove some or all of the character string. This would modify the data message, which would require the original data message to be stored elsewhere in the network (e.g., in an external memory) if the original data message is needed later.

Also, instead of searching of character patterns, some embodiments use the above-described data plane circuits to search for regular expressions that include a set of two or more characters in a data message payload. To do this, some embodiments configure the data plane circuit to conjunctively perform different character pattern searches for different character patterns of the expression. When all the character patterns are identified in the desired sequence in one or more passes of the data message through the data plane circuit, the data plane circuit records the identification of the expression, and returns the data message or an identifier for the data message to the server or another device with a notification that the expression has been identified and a set of parameters associated with the identified expression.

In still other embodiments, the data plane circuit searches for character patterns and/or expressions across multiple data messages. To do this, the data plane circuit in these embodiments records partial patterns that it recognizes in different data messages in registers. Once it determines that the registers indicate that all of one pattern or multiple related patterns have been detected, the data plane circuit returns the data messages or identifiers for the data messages to the server or another device with a notification that the pattern or related patterns expression have been identified and a set of parameters associated with the identified pattern(s). Accordingly, one of ordinary skill in the art would understand that the invention is not to be limited by the foregoing illustrative details, but rather is to be defined by the appended claims.

1. A method of detecting a set of one or more character patterns stored in data messages passing through a network, the method comprising:
generating a state machine comprising (i) a plurality of states comprising partial-pattern states and at least one full-pattern state and (ii) a plurality of transitions between the states, each transition associated with a match of a set of characters in a data message and at least a portion of at least one pattern; and
providing configuration data to configure a data plane circuit of a forwarding element to implement the state machine, in order to search data messages to identify one or more character patterns in the data messages.

2. The method of claim 1, wherein the state machine transitions comprise at least one transition associated with a match of a plurality of characters in a data message with a multi-character portion of at least one pattern.

3. The method of claim 1, wherein
the data plane circuit comprises a plurality of match-action units,
the configuration data specifies a plurality of match-action pairs for the match-action units to implement,
each pair including (i) a match parameter set that includes a first state of the state machine and a set of characters, and (ii) an action parameter set that specifies a second state,
when a current state of the state machine and a processed character portion stored in a data message match the match parameter set of a particular match-action pair, the match-action unit that implements the particular match-action pair changes the current state of the state machine from the first state to the second state.

4. The method of claim 3, wherein the set of characters of each match parameter set in a group of match parameter sets of a group of match-action pairs comprises more than one character.

5. The method of claim 4, wherein for at least a subset of match parameter sets, each particular character set in at least a subset of the character sets with more than one character comprises at least one wildcard character that matches any potential character in a character portion that is being compared to the character set.

6. The method of claim 5, wherein the match-action units comprise TCAM match tables used to store match parameter sets with at least one wildcard character.

7. The method of claim 6, wherein the match-action units comprise SRAM match tables used to store match parameter sets that do not use wildcard characters.

8. The method of claim 5, wherein at least one match-action unit comprises
a TCAM match table to store match parameter sets with at least one wildcard character, and
an SRAM match table to store match parameter sets that do not use wildcard characters,
wherein when one set of characters in a data message matches match parameter sets in the TCAM and SRAM match tables, the SRAM match parameter set is identified as the matching match parameter set,
wherein when one set of characters in a data message matches a plurality of match parameter sets in the TCAM match table, the match parameter set with a highest priority in the TCAM match table is identified as the matching match parameter set.

9. The method of claim 1, wherein the data plane circuit is configured to recirculate a data message when the data plane circuit cannot check all the characters contained in the data message after having the data message traverse through one pass of the data plane circuits message processing stages.

10. The method of claim 3, wherein
each match parameter set stores its set of characters as hash values of the set of characters instead of storing the set of characters in order to reduce a size of the match parameter set;
the data plane circuit is configured to compare a plurality of characters in a data message with a set of characters of a match parameter set by generating a hash value of the plurality of characters and comparing the hash value with the hash of the set of characters that are stored in the match parameter set.

11. The method of claim 3, wherein each of a set of match-action units comprises multiple match-action unit (MAU) subsets, each of which implements a different state machine in parallel with the other MAU subsets of its match-action unit.

12. The method of claim 11 further comprising dividing the generating state machine into a plurality of state machines to be implemented by the data plane circuit in parallel.

13. The method of claim 1, wherein providing configuration data comprises providing the configuration data to a control plane circuit associated with the data plane circuit, in order for the control plane circuit to supply the configuration data to the data plane circuit.

14. The method of claim 1, wherein providing configuration data comprises forwarding he configuration data in-band to the data plane circuit.

15. A non-transitory machine readable medium storing a program for detecting a set of one or more character patterns stored in data messages passing through a network, the program for execution by at least one processing unit, the program comprising sets of instructions for:
generating a state machine comprising (i) a plurality of states comprising partial-pattern states and at least one full-pattern state and (ii) a plurality of transitions between the states, each transition associated with a match of a set of characters in a data message and at least a portion of at least one pattern; and
providing configuration data to configure a data plane circuit of a forwarding element to implement the state machine, in order to search data messages to identify one or more character patterns in the data messages.

16. The non-transitory machine readable medium of claim 15, wherein the state machine transitions comprise at least one transition associated with a match of a plurality of characters in a data message with a multi-character portion of at least one pattern.

17. The non-transitory machine readable medium of claim 15, wherein
the data plane circuit comprises a plurality of match-action units,
the configuration data specifies a plurality of match-action pairs for the match-action units to implement,
each pair including (i) a match parameter set that includes a first state of the state machine and a set of characters, and (ii) an action parameter set that specifies a second state,
when a current state of the state machine and a processed character portion stored in a data message match the match parameter set of a particular match-action pair, the match-action unit that implements the particular match-action pair changes the current state of the state machine from the first state to the second state.

18. The non-transitory machine readable medium of claim 17, wherein the set of characters of each match parameter set in a group of match parameter sets of a group of match-action pairs comprises more than one character.

19. The non-transitory machine readable medium of claim 18, wherein for at least a subset of match parameter sets, each particular character set in at least a subset of the character sets with more than one character comprises at least one wildcard character that matches any potential character in a character portion that is being compared to the character set.

20. The non-transitory machine readable medium of claim 15, wherein the data plane circuit is configured to recirculate a data message when the data plane circuit cannot check all the characters contained in the data message after having the data message traverse through one pass of the data plane circuits message processing stages.
